(19) United States
(12) Patent Application Publication
(10) Pub. No.: US 2018/0281960 A1
(43) Pub. Date: Oct. 4, 2018

(54) AIRLINE SEAT AND AIRLINE SEATBELT SYSTEM

(71) Applicant: Adient Engineering and IP GmbH, Burscheid (DE)

(72) Inventors: Andreas WEINGART, Niederkirchen (DE); Peter CANSFIELD, Dexter, MI (US)

(21) Appl. No.: 15/477,403

(22) Filed: Apr. 3, 2017

(51) Int. Cl. B64D 11/06

(52) U.S. Cl. CPC B64D 11/062; B64D 11/0696; B64D 11/064

(57) ABSTRACT

An airline seatbelt arrangement (10) includes an airline seat frame (5) with a seat base (3) connected to the airline seat frame (5). The seat base has a cushion upper surface (30). A seatbelt retractor (11) is connected to the seat frame (5). A seatbelt retractor (11) has a seatbelt (20) with a seatbelt tongue (12) connected to the seatbelt (20). A seatbelt guide (36, 36′, 36″, 35, 35′, 35″) is connected to the seat base. The seatbelt guide guides the seatbelt and seatbelt tongue from a retracted position to a deployed position within an angular range relative to the seatbelt connection location, whereby the seatbelt and seatbelt tongue may be positioned in the angular range relative to the cushion upper surface in the deployed position. The seatbelt guide may include a recess formed in the seat base and extending from a seatbelt retractor location to the cushion upper surface.

### FIELD OF THE INVENTION

The present invention relates to a vehicle seat and more particularly relates to an airline seat that can move between a taxi and takeoff and landing (TTL) position and a lie flat position as well as to a seatbelt arrangement for such an airline seat.

### BACKGROUND OF THE INVENTION

Airline seats are known which move between a TTL position and a lie flat position. In between these two extreme positions there are various positions with the backrest reclined to some extent, inclined to various degrees relative to the seat base (cushion) and with the leg rest (ottoman) raised various degrees relative to the seat base. Although this large degree of movement of the airline seat is very desirable, it is somewhat problematic to match this large degree of movement to a safe and comfortable use of the seatbelt by the airline passenger. Further, known seatbelt arrangements for airline seats may have the problem that the seatbelt lies in an awkward position during non use, potentially blocking the user from sitting down. However, known seatbelt arrangements also may have the problem that one of the belt portion with the tongue and the portion with the buckle becomes lodged or wedged in the vehicle seat, such as between the backrest and the seat base, or falls between or to the side of the seat such that it is difficult to grasp or even find the belt portion.

DE 10 243 633 A1 discloses a vehicle seat that includes a function element mounted in a recess of the upholstered backrest cushion and covered by a padded filler which is attached to the backrest by an articulated joint. This allows it to be folded into a space between the backrest and the seat base. The function element is a stirrup-shaped fixing element such as used for detachably fixing child seats. The seat features allow the fixing element to be kept out of the way from active portions of the backrest. However, the arrangement appears to particularly not be useful for seatbelt features. Instead, the fixing element provides an anchor or connection which, due to its connection of the backrest, is useful for only small forces, such as forces associated with child seats.

DE 31 47 045 A1 discloses a multi-seat arrangement which can preferably be used for vehicles, and in particular for buses, in the latter case as a double-seat arrangement. The multi-seat arrangement has at least two individual seats, namely a window seat and an aisle seat. It also has a seat support frame which supports the seats and rests on a window-side bracket of the bus and is supported on the vehicle floor by a leg on the aisle side. The aisle-side seat can be displaced transversely with respect to the seat direction. For this, a seat rail and a lower rail are provided below seat carrying frames. The seat frames have seat rails that connect together two side backrest carrier legs of a seat. A belt buckle or a retractor for a lap belt is arranged in a transition area of the side backrest carrier legs. The belt forces are thereby directly introduced into the seat rail and the lower rail. The arrangement is advantageous with regard to allowing the transverse displacement of a seat while also providing a force connection for the belt buckle or retractor. However, the arrangement does not provide practical or advantageous features for airline seats.

### SUMMARY OF THE INVENTION

It is an object of the invention to provide an airline seat and an airline seatbelt arrangement which reduces the potential of inadvertent or accidental use of the seatbelt while providing a comfortable use of the seatbelt over a range of airline seat positions. It is particularly an object of the invention to provide an airline seatbelt system which allows a variation of angular position of the seatbelt tongue end and the buckle end to safely restrain a user in airline seat positions that can vary between a TTL position and a lie flat position. It is further an object of the invention to provide an airline seat and an airline seatbelt arrangement which conveniently positions the seatbelt buckle and tongue for use without these features being in the way when the user is seated in the seat or leaves the seat.

According to the invention, an airline seatbelt arrangement is provided comprising an airline seat frame and a seat base connected to the airline seat frame. The seat base has a cushion upper surface. A seatbelt retractor is provided with a seatbelt. The seatbelt retractor is connected to the airline seat frame at a seatbelt connection location. A seatbelt tongue is connected to the seatbelt. A seatbelt guide is connected to the seat base, the seatbelt guide providing a guideway for guiding the seatbelt and seatbelt tongue from a retracted position to a deployed position within an angular range relative to the seatbelt connection location. The seatbelt and seatbelt tongue may be positioned in the angular range relative to the cushion upper surface in the deployed position.

The seatbelt guide may advantageously comprise a recess formed in the seat base and extending from a seatbelt retractor location to the cushion upper surface. The seatbelt retractor may be pivotably mounted to the seat frame and may be disposed in the recess formed in the seat base. The seatbelt guide may further comprise a guide cover forming a portion of the cushion upper surface. The guide cover may include an upper cover portion forming the portion of the cushion upper surface and a side cover portion. The upper cover portion may include an elongate slot allowing the seatbelt to be moved, within the angular range, forward and rearward, within the elongate slot, relative to the seat base. The elongate slot may be sized relative to the tongue or relative to a belt to tongue connection region such that the tongue or at least a portion of the tongue is maintained so as to be graspable by a user of the seatbelt. The relative dimensions avoid the possibility of the tongue moving downwardly into the in the recess formed in the seat base.

With one embodiment the seatbelt guide comprises a guide cover forming a portion of the cushion upper surface, wherein the guide cover includes a flip up top that is pivotably connected to the seat base to pivot between an open position providing access to the seatbelt and the seatbelt tongue and a closed position closing off access to the seatbelt and seatbelt tongue. The flip up top has an upper surface that forms a continuation of the cushion upper surface. The flip up top of the guide cover may include a belt pass through slot. This allows the belt to extend through the flip up top with the flip up top closed. The guide cover may also include an upper cover portion that is below and is covered by the flip up top. The upper cover portion may include an elongate slot allowing the seatbelt to be moved, within the angular range, forward and rearward, within the elongate slot, relative to the seat base. The elongate slot may be sized relative to the tongue or relative to a belt to tongue connection region (at which the belt may pass though an opening of the tongue element and wrap back over a portion of the tongue element to join the belt and the tongue element) such that the tongue or at least a portion of the tongue is maintained above the upper cover portion so as to be graspable by a user of the seatbelt, when the flip up top is open. The relative dimensions avoid the possibility of the tongue moving downwardly into the in the recess formed in the seat base.

The recess advantageously has an angled forward wall forming a retractor forward pivot stop and the recess has a rear wall forming a retractor rear pivot stop. The retractor forward pivot stop and the retractor rear pivot stop set the angular range. The retractor may be pivotable between the retractor forward pivot stop and the retractor rear pivot stop.

According to another embodiment of the invention, the seatbelt retractor is located below the seat base. The recess extends through the seat base from below the seat base to the cushion upper surface. The recess may have an elongate slot with a forward edge forming a belt forward stop and the recess may have rear edge forming a belt rear stop. The seatbelt may be moved, within the angular range, forward and rearward, within the elongate slot, relative to the seat base.

According to another embodiment of the invention, the seatbelt retractor is located below the seat base. The seatbelt guide comprises side seat cushion straps forming a belt passageway recess. The seatbelt guide is provided at a lateral side of the seat base. At an upper edge of the seatbelt guide, the seatbelt guide forms an elongate slot with a forward edge forming a belt forward stop and a rear edge forming a belt rear stop. The seatbelt may be moved, within the angular range, forward and rearward, within the elongate slot, relative to the seat base.

The seatbelt arrangement further comprises a buckle and a buckle connecting strap connecting the buckle to the airline seat frame. The buckle and buckle strap are pivotably mounted to the seat frame. The seat base includes a buckle guide recess receiving the buckle and/or the buckle strap.

The buckle guide recess has a forward and rear wall that are dimensioned such that the buckle connecting strap are pivotable to move within the buckle guide recess forward and rearward relative to the seat base. The buckle guide recess forward and rear wall form stops that allow the buckle and the buckle connecting strap to pivot within the angular range. In particular, the buckle guide recess has a forward wall forming a buckle or buckle connecting strap forward pivot stop and the buckle guide recess has a rear wall forming a buckle or buckle connecting strap rear pivot stop. The buckle or buckle connecting strap is pivotable between the buckle forward pivot stop and the buckle rear pivot stop.

The buckle guide recess may be formed as with a sliding strap connected to a lateral side of the seat base. The buckle connecting strap extends through a region between the seat base and the sliding strap. The buckle connecting strap is guided by the sliding strap for movement of the buckle, forwardly and rearwardly, relative to the seat base within the angular range.

The buckle guide recess may be formed as through recess. In this case the seat base includes and defines the through recess. The through recess passes through the seat base.

The connecting strap extends through the through recess from a connection location with the seat frame to a buckle location above the cushion upper surface. The buckle connecting strap extends through the seat base from below the seat base to the cushion upper surface. The recess may have an elongate slot with a forward edge forming a buckle connecting strap forward stop and the recess may have rear edge forming a buckle connecting strap rear stop. The connection location provides a pivot connection. The buckle connecting strap may move forwards and rearwards within the recess, within the angular range, within the elongate slot, relative to the seat base.

The seatbelt guide may provide a guideway for guiding the seatbelt from a retracted position to a deployed position and for maintaining and defining an angular position of the seatbelt and seatbelt tongue relative to the cushion upper surface.

According to another aspect of the invention, an airline seat is provided comprising an airline seat frame, a seat backrest connected to the seat frame and a seat base connected to the airline seat frame. The seat base has a cushion upper surface and a seat base forward edge. A seatbelt retractor, with a seatbelt, is connected to the airline seat frame at a seatbelt connection location. A seatbelt tongue is connected to the seatbelt. A seatbelt guide is connected to the seat base and provides a guideway. The seatbelt guide guides the seatbelt and seatbelt tongue from a retracted position to a deployed position, within an angular range relative to the seatbelt connection location. The seatbelt and seatbelt tongue may be positioned in the angular range relative to the cushion upper surface in the deployed position.

The airline seat further comprises a buckle and a buckle connecting strap. The connecting strap connects the buckle to the airline seat frame. The buckle is pivotably mounted to the seat frame. A buckle guide recess receives the buckle and/or the buckle strap. The seatbelt guide comprises a recess formed in the seat base and extending from a seatbelt retractor location to the cushion upper surface.

The airline seat according to the invention may further comprise an adjustment frame/mechanism for adjusting a position of the airline seat frame to move the seat backrest relative to the seat base between a taxi, takeoff and landing position and a lie flat position. The seatbelt guide guides a position of the seatbelt between a seatbelt lie flat position, with the seatbelt extending from the seatbelt guide essentially parallel to a seat base forward edge and a seatbelt taxi, takeoff and landing position with the seatbelt extending from the seatbelt guide toward the seat base forward edge. On an opposite side, the buckle guide recess guides a position of the buckle between a buckle lie flat position, with the buckle extending from the buckle guide recess essentially parallel to a seat base forward edge and a buckle taxi, takeoff and landing position with the buckle extending from the buckle guide recess toward the seat base forward edge.

As with the seatbelt assembly (system), the airline seat may have the seatbelt retractor pivotably mounted to the seat frame and is disposed in the recess formed in the seat base. The recess has a forward wall forming a retractor forward pivot stop and the recess has a rear wall forming a retractor rear pivot stop. The retractor forward pivot stop and the retractor rear pivot stop set an angular range corresponding to the seatbelt lie flat position and the seatbelt taxi, takeoff and landing position as the extremes. The retractor is pivotable between the retractor forward pivot stop and the retractor rear pivot stop. The buckle guide recess has a forward wall forming a buckle or buckle connecting strap forward pivot stop and the buckle guide recess has a rear wall forming a buckle or buckle connecting strap rear pivot stop. The a buckle or buckle connecting strap is pivotable between the a buckle or buckle connecting strap forward pivot stop and the a buckle or buckle connecting strap rear pivot stop. The stops set an angular range corresponding to the buckle lie flat position and the buckle taxi, takeoff and landing position as the extremes of the angular range.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1A is a side view showing an airline seat in the TTL position with a seatbelt system according to the invention;

FIG. 1B is a side view showing the airline seat of FIG. 1A in a neutral position;

FIG. 1C is a side view showing the airline seat of FIG. 1A in the lie flat position;

FIG. 2A is a perspective view of the airline seat showing a seatbelt buckle angle for the TTL position;

FIG. 2B is a perspective view of the airline seat showing a seatbelt buckle angle for the neutral position;

FIG. 2C is a perspective view of the airline seat showing a seatbelt buckle angle for the lie flat position;

FIG. 3 is a side view of the seat base showing the tongue side of the seatbelt system according to the invention;

FIG. 4 is a perspective view of the airline seat showing the tongue side of the seatbelt system of FIG. 4;

FIG. 5 is a side view of the seat base showing the buckle side of the seatbelt system according to the invention;

FIG. 6 is a perspective view of the airline seat showing the buckle side of the seatbelt system of FIG. 5;

FIG. 7A is a perspective view of the tongue side of the seatbelt system of FIG. 4, with a cover arrangement covering the retractor and belt recess and showing the cover arrangement with the top in a closed position;

FIG. 7B is a perspective view of the airline seat with seatbelt system of FIG. 7A showing the cover arrangement with the top flipped to an open position;

FIG. 8 is a perspective view of another airline seatbelt system embodiment with a cover with belt guide covering the retractor and belt recess;

FIG. 9 is a perspective view showing the embodiment of FIG. 8 with the cover removed;

FIG. 10 is a perspective view of another airline seatbelt system embodiment with a cover with belt guide covering the retractor and belt recess;

FIG. 11 is a perspective view showing the embodiment of FIG. 10 with the cover removed;

FIG. 12 is a top view of the vehicle seat, in the lie flat position, showing the tongue side of another airline seatbelt system embodiment;

FIG. 13 is a top view of the vehicle seat, in the lie flat position, showing the buckle side of the airline seatbelt system embodiment of FIG. 12;

FIG. 14 is a side broken away view of the seat base showing the tongue side of another airline seatbelt system embodiment; and

FIG. 15 is a perspective view showing seatbelt retractor position below the seat base according to the airline seatbelt system embodiments of FIGS. 12 and 14.

### DESCRIPTION OF THE PREFERRED EMBODIMENTS

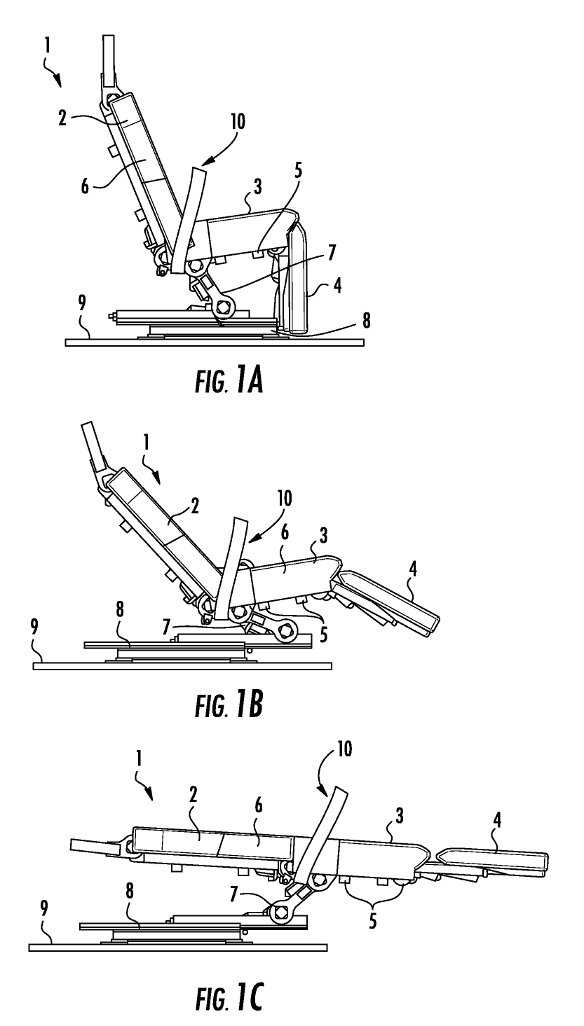

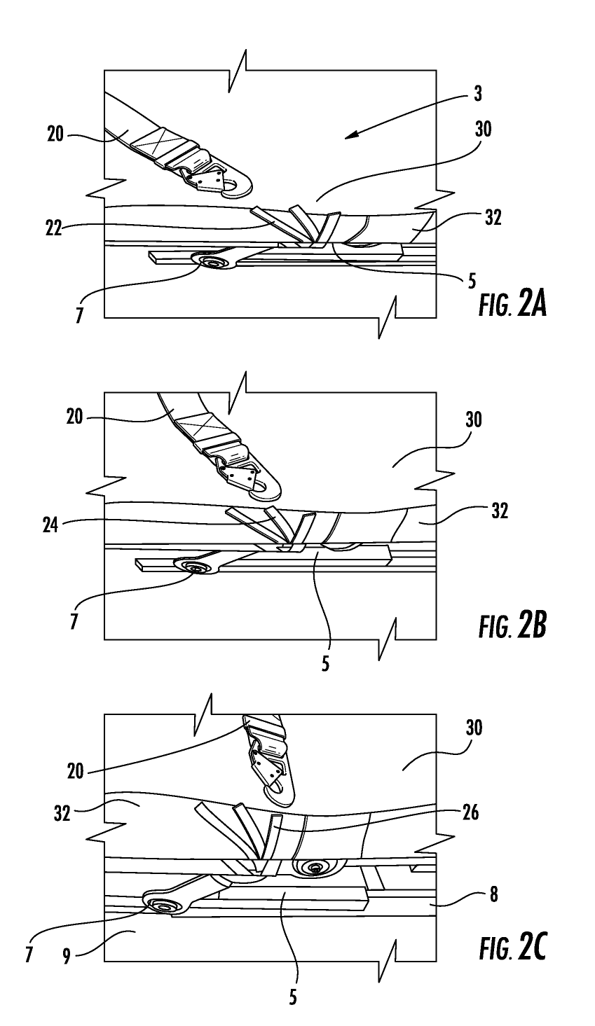

Referring to the drawings in particular, FIG. 1A shows an airline seat, generally designated 1, according to the invention. FIGS. 1A, 1B and 1C show the airline seat 1 in the TTL, neutral and lie flat positions respectively. The airline seat 1 includes a backrest 2, a seat base (cushion) 3 and a leg rest (ottoman) 4. These features are provided with a seat frame 5 with trim and foam/padding 6. The parts of the frame 5 are connected by frame joints of the frame 5. The relative position of the backrest 2, the seat base 3 and the leg rest 4 are determined and set by an adjustment frame/mechanism 7. The adjustment frame 7 is connected to the airline floor 9 via a subframe 8. The adjustment frame/mechanism 7 and subframe 8 include a rail (track) connection arrangement. The airline seat includes an airline seatbelt arrangement—airline seatbelt system—generally designated 10.

The airline seat is configured to move between the extreme positions, namely the TTL position shown in FIG. 1A and the lie flat position shown in FIG. 1C. The position and path of the seatbelt 20 changes between these extreme positions. FIG. 2A shows the buckle side of the seatbelt arrangement indicating the seatbelt buckle TTL angle 22. The seatbelt TTL angle 22 at the tongue side of the seatbelt arrangement is essentially the same. This TTL angle 22 represents a seatbelt and buckle angle which is optimal for the seatbelt 20 to safely restrain the passenger with the airline seat 1 in the TTL position. The position of the belt 20 (extending toward the buckle 14) at the TTL angle 22 is shown in FIG. 2A. The belt 20 extends over the cushion upper surface 30 toward the cushion buckle side surface 32. In FIG. 2B the angle of the belt 20 is shown in the neutral position with a neutral position angle 24. This neutral position angle 24 represents a seatbelt angle and buckle angle which is optimal for the seatbelt 20 to safely restrain the passenger with the airline seat 1 in the neutral position. FIG. 2C shows the belt 20 extending over the cushion upper surface 30 toward the cushion buckle side surface 32 at the lie flat angle 26. The lie flat angle 26 represents a seatbelt/buckle angle which is optimal for the seatbelt 20 to safely restrain the passenger with the airline seat 1 in the lie flat position. The airline seatbelt system 10 provides features at a belt and tongue anchor side and at a buckle anchor side to accommodate each of the TTL angle 22, the neutral angle 24 and the lie flat angle 26.

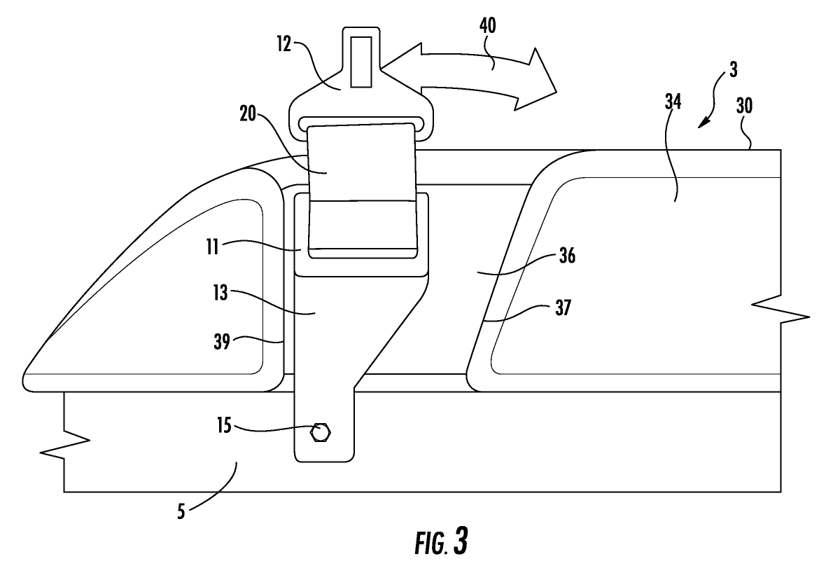

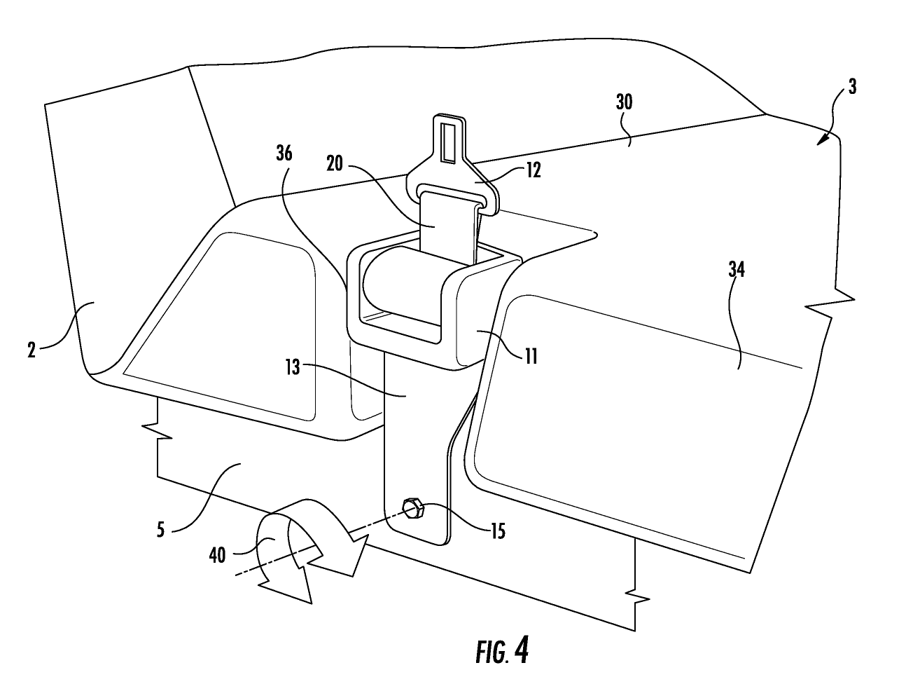

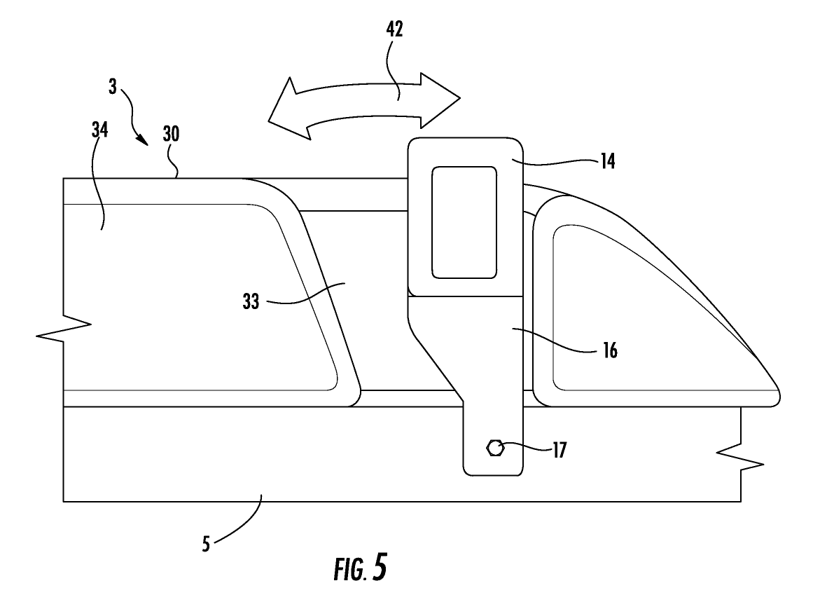

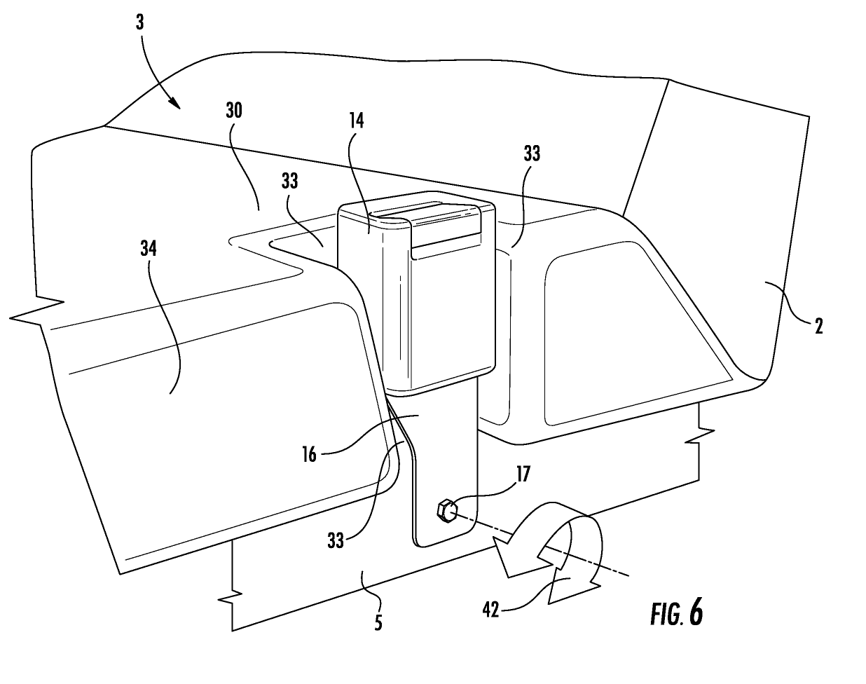

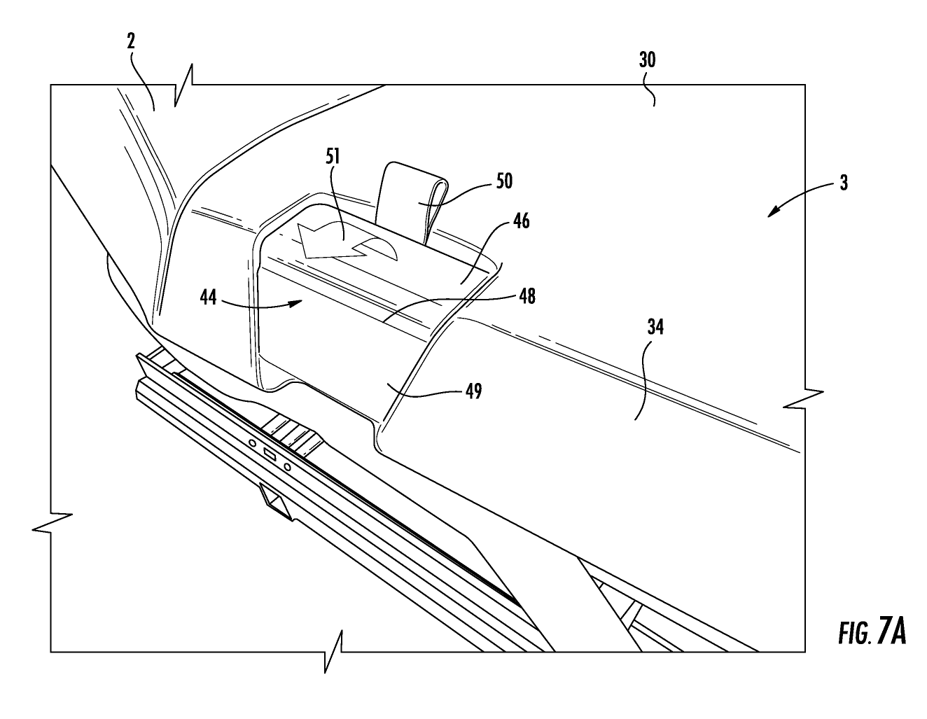

FIGS. 3 and 4 show the seatbelt system at a belt and tongue anchor side. FIG. 3 shows the tongue side surface 34 of the seat base 3 with a recess 36. The recess 36 provides a space for receiving a seatbelt retractor 11. The seatbelt retractor 11 is mounted on a retractor support 13 which pivots about a pivot axis formed by support pivot/bolt (seatbelt connection location) 15. The support pivot/bolt 15 is fixedly connected to the seat frame 5, particularly the seat base portion of the frame 5. The retractor 11 comprises a mechanism that feeds out and retracts the belt 20. The retractor 11 may be configured with known retractor features. For example, the retractor may be as disclosed in U.S. Pat. No. 4,323,205 (the entire contents of U.S. Pat. No. 4,323,205 are incorporated herein by reference). The belt 20 is provided with a seatbelt tongue 12. The belt 20 and the tongue 12 may be extended to the other side of the cushion 34 for engagement with a buckle 14. Based on the configuration of the recess 36 and based on the mounting of the retractor support 13 for pivoting at support pivot/bolt 15, the retractor support 13 may pivot along the directions of arrow 40. The recess 36 includes an angled forward wall 37 and rear wall 39 that is essentially vertical. The walls 37 and 39 act as stops as to movement of the retractor 11 and the retractor support 13. This establishes the angular range of the pivot. The shape of the recess 36 is configured such that the belt 20 may extend essentially straight across for the lie flat position with lie flat angle 26 or may be extended at an angle up to the TTL angle 22. The angled forward edge of the recess 36 is preferably selected such that with the retractor 11 and the retractor support 13 fully forward, bearing on the forward surface 37 of the recess 36, the belt 20 extends across in the TTL position. The configuration allows full angular positioning between the extreme lie flat and the TTL positions and thereby provides improved safety aspects.

The recess 36 further allows for compact arrangement in which the retractor and the tongue 12 and belt 20 are positioned inwardly of the cushion tongue side surface 34. This can further be seen in FIG. 4, wherein each portion of the retractor, 14, the retractor support 13, the belt 20 and the tongue 12 are positioned inwardly of the cushion tongue side surface 34. The retractor 14 and the retractor support 13 may advantageously be disposed below the cushion upper surface 30.

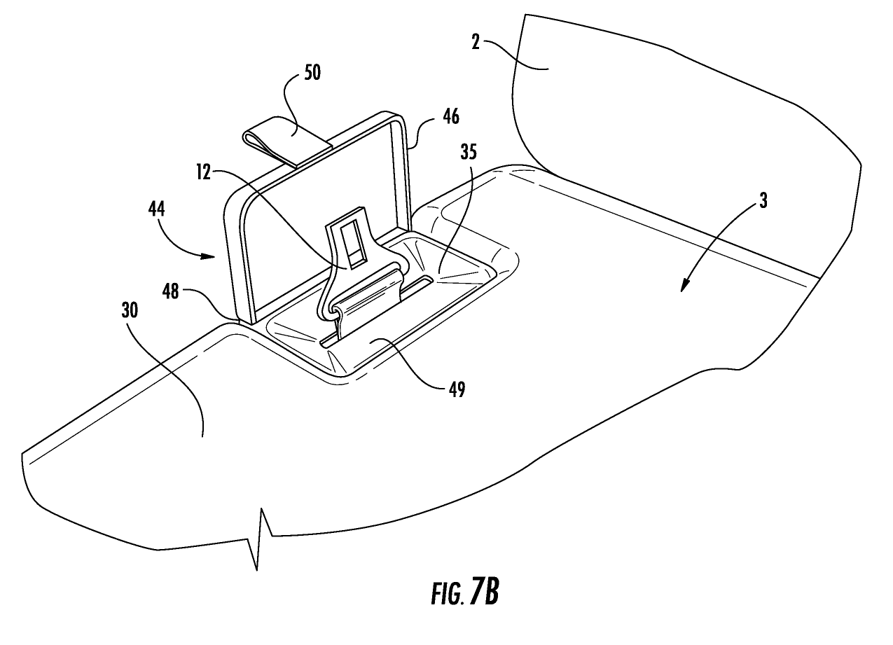

FIGS. 5 and 6 show the seatbelt system at a buckle anchor side or buckle side arrangement of the airline seatbelt system 10. The buckle 14 is mounted on a buckle strap 16 which is connected to the frame 5, particularly the seat base portion of the frame 5, by a buckle strap pivot/bolt 17. The buckle 14 and strap 16 are disposed within a buckle guide recess 33.

The configuration of the buckle guide recess 33 is quite similar to the retractor/belt guide recess 36. The recess 33 has a forward angled wall which acts as a stop and presents the maximum forward pivot angle of the buckle 14 relative to the buckle strap pivot/bolt 17. This allows movement in the directions 42 about the pivot 17 within the limits provided by the forward and rear walls of the recess 33. As shown in FIG. 5, the buckle 14 is in the lie flat position, with the buckle 14 and support 16 adjacent to the rearward wall of the recess 33. The configuration allows movement between this lie flat position with the lie flat angle 26 to the TTL position in which the buckle 14 and buckle strap 16 are pivoted forward, and bear against the front stop wall of the recess 33. As can be seen in FIGS. 5 and 6, the buckle 14 and the support 16 are position essentially inwardly of the cushion buckle side surface 32. In the embodiment shown in FIGS. 5 and 6, the buckle 14 extends somewhat above the cushion upper surface 30. However, the buckle 14 male also be configured with the buckle strap 16 such that the upper edge of the buckle 14 is below or even with the cushion upper surface 30.

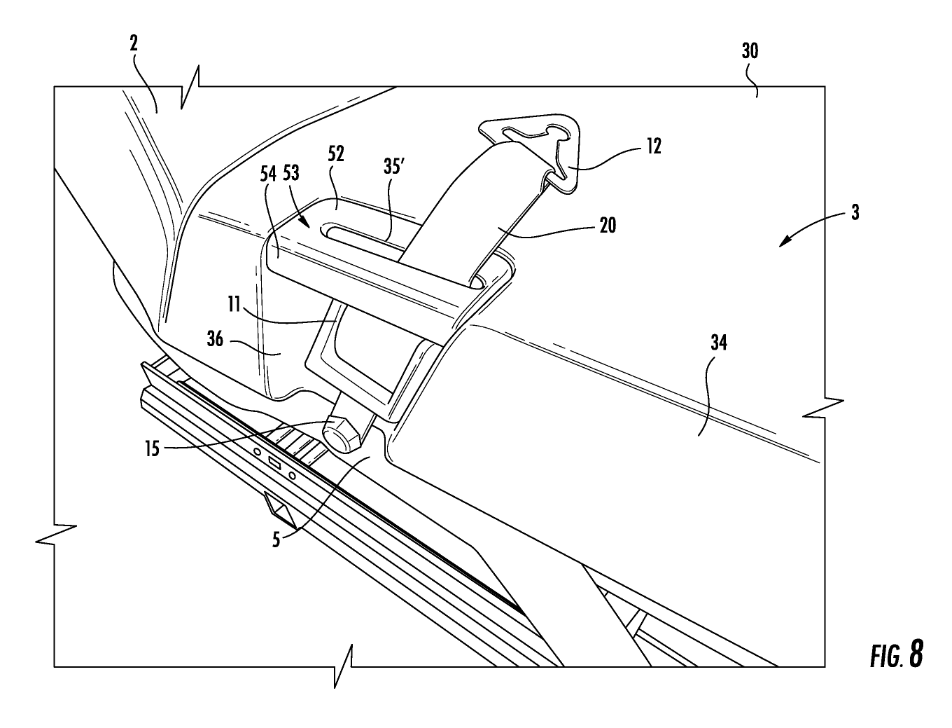

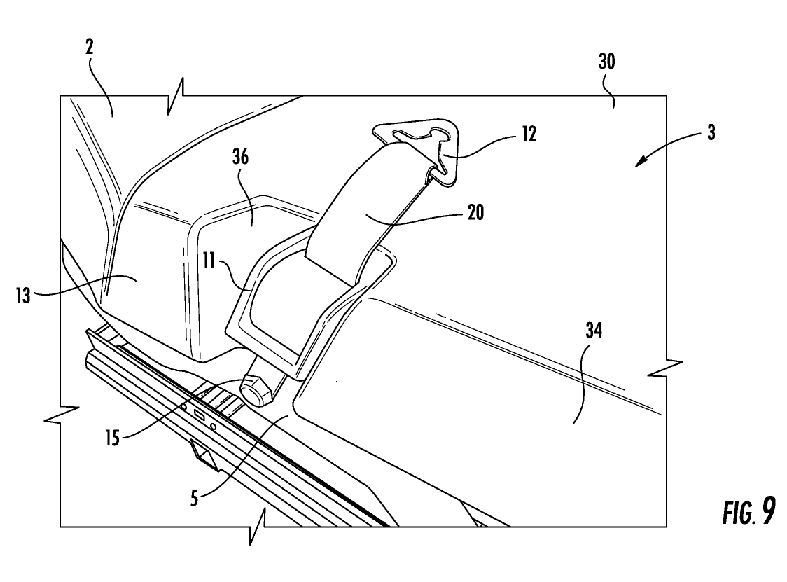

FIG. 7A shows the seat base 3 with a cover assembly 44 covering the recess 36. The cover assembly 44 is particularly used on the tongue side of the airline seatbelt assembly 10 but could also be adapted for the buckle side. The cover assembly 44 may be fixed to the seat base 3, such as with a snap in features of the seat base 3 and the cover assembly 44 or with fasteners, bonding or otherwise. The cover assembly 44 includes a cover flip top 46 connected to a cover base 49 by a cover hinge 48. A pull tab 50 is connected to the cover flip top 46 to allow the flip top 46 to be opened, pivoting the flip top 46 in the cover opening direction 51. The hinge 48 is formed as a simple material hinge. The material hinge 48 may be a fabric, a plastic layer or leather covering an outer surface of the fliptop cover 46 and covering an outer surface of the cover base 49.

As can be seen in FIG. 7B, the cover base 49 includes an upper surface forming a seatbelt guide opening 35. The seatbelts guide opening 35 acts as a guide surface. The opening 35 is sized so that the tongue 12 is maintained on the upper side of the upper surface of the cover base 49. This may be with a sizing of the belt to tongue 12 connection with dimensions relative to the dimensions of the guide opening 35 so that the tongue 12 stays above the upper surface of the cover base 49. The region between the upper surface and the cover flip top 46 is preferably sized to allow the buckle 12 to be accommodated in the space with the flip top 46 closed. The flip top cover 46 may be provided with a belt passage allowing the belt 20 to extend out of the cover 46 with the cover 46 closed. Such a belt passage may also be sized to allow the tongue 12 to be maintained either outside the cover 46 or inside the cover 46, with the cover 46 closed. The guide surface opening or guide slot 35 (as well as any passage in the cover 46) has a length in the forward and aft direction to allow the belt 20 to be extended at the lie flat angle 26 or the TTL angle 22 or any angle in between these extremes. Based on the angled forward wall 37 of the recess 36 and based on the rear surface 39 of the recess 36, which act as stops, the retractor 11 hits the stops thereby preventing the belt 20 from being bunched and preventing the belt 20 from being pinched at the forward most and rearward most angular positions 22 and 26.

FIG. 8 shows an alternative embodiment of the airline seatbelt system 10. The recess 36 has a cover 53 with upper cover portion 52 and side cover portion 54. Cover portion 52 covers the recess 36 at the cushion upper surface 30. The recess 36 is partially covered on the cushion side surface 34 with a side cover portion 54. The cover 53 may be fixed to the seat base 3, such as with a snap in features of the seat base 3 and the cover 53 or may be fixed by fasteners, bonding or otherwise. The upper cover portion 52 includes a seatbelt guide slot 35′. The guide slot 35′ may again be sized relative to the dimensions of the tongue to belt connection such that the tongue 12 is maintained above the upper cover portion 52. The guide slot 35′ has a length in the forward and aft direction to allow the belt 20 to be extended at the lie flat angle 26 or the TTL angle 22 or any angle in between these extremes.

FIG. 9 shows the embodiment of FIG. 8 with the cover 52, 54 removed. As can be seen, the seatbelt retractor 11 and the retractor support 13 are pivoted forward to abut against the angled forward wall corresponding to the TTL position. The angled forward wall of the recess 36 acts as a stop with the aft wall of the recess 36 acting as another stop (and defining the lie flat angle).

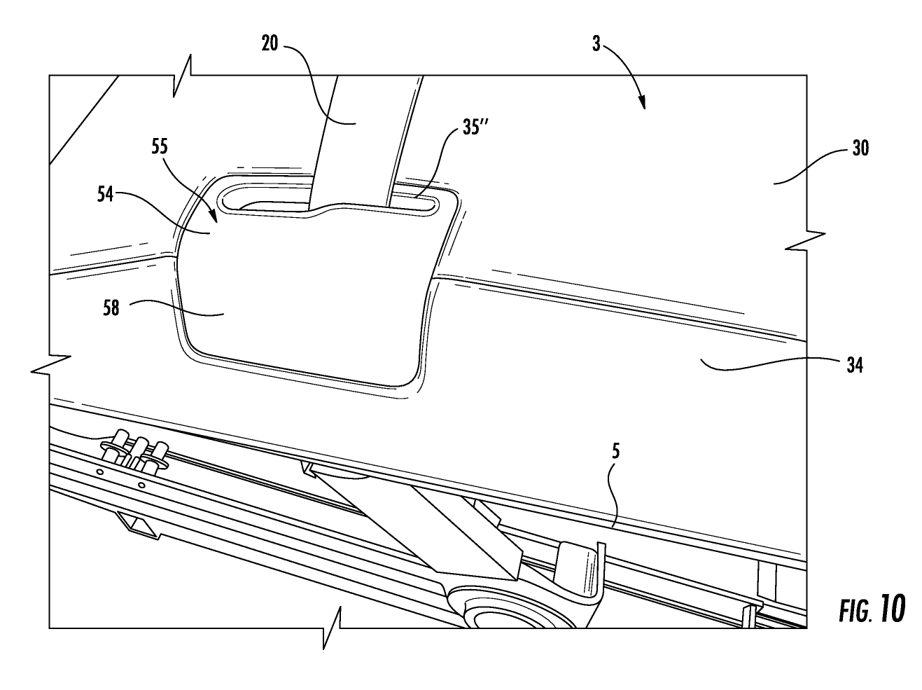

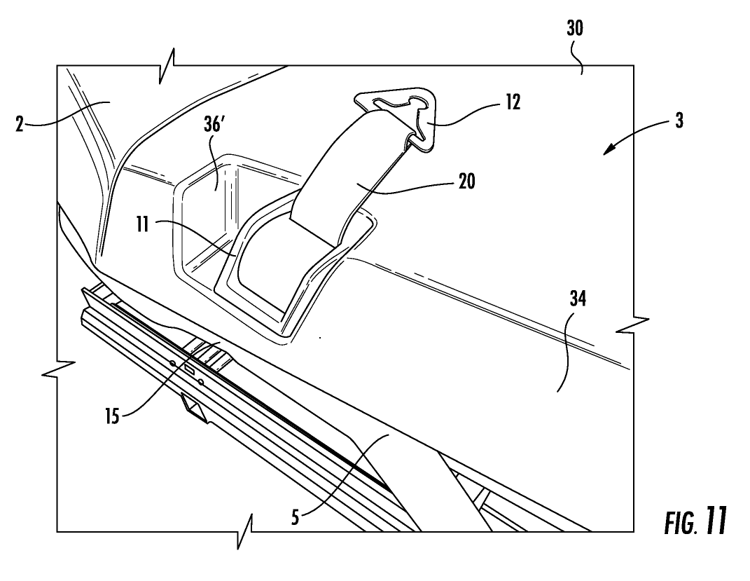

FIG. 10 shows an alternative embodiment of the airline seatbelt system 10. The retractor/belt guide recess 36′ is formed so as to maintain a portion of the cushion tongue side surface 34 of the cushion 3 below the recess 36′ as can be seen in FIG. 11. The retractor/belt guide recess 36′ includes a lower slot allowing the retractor support 13 to pass through the seat base 3 to the fixation point with the frame 5 at the support pivot/bolt 15. This configuration covers the seatbelt retractor 11 and retractor support 13 more fully. The opening to the recess 36, is covered with a cover 55. The cover 55 including an upper cover portion 54 and a lower side cover portion 58 as shown in FIG. 10. The cover 55 may be fixed to the seat base 3, such as with a snap in features of the seat base 3 and the cover 55 or fixed by fasteners, bonding or otherwise. The upper cover portion 54 includes a seatbelt guide slot 35″. The seatbelt guide slot 35″ has a contour which includes distinct regions sized to the width of the seatbelt 20 and corresponding to the extreme angular positions of the belt 20. The forward region of the seatbelt guide slot 35″corresponds to the TTL angle 22. The aft region of the seatbelt guide slot 35″ corresponds to the lie flat angle 26. The retractor/belt guide recess 36′ again has an angled forward wall and a rear wall, which act as stops (or in the alternative, the lower slot allowing the retractor support 13 to pass through the seat base 3 may act as stops to the retractor support 13). The retractor 11 (or the retractor support 13) hits the stops, which prevents the belt 20 from being bunched and preventing the belt 20 from being pinched in the seatbelt guide slot 35″ at the forward most and rearward most angular positions 22 and 26.

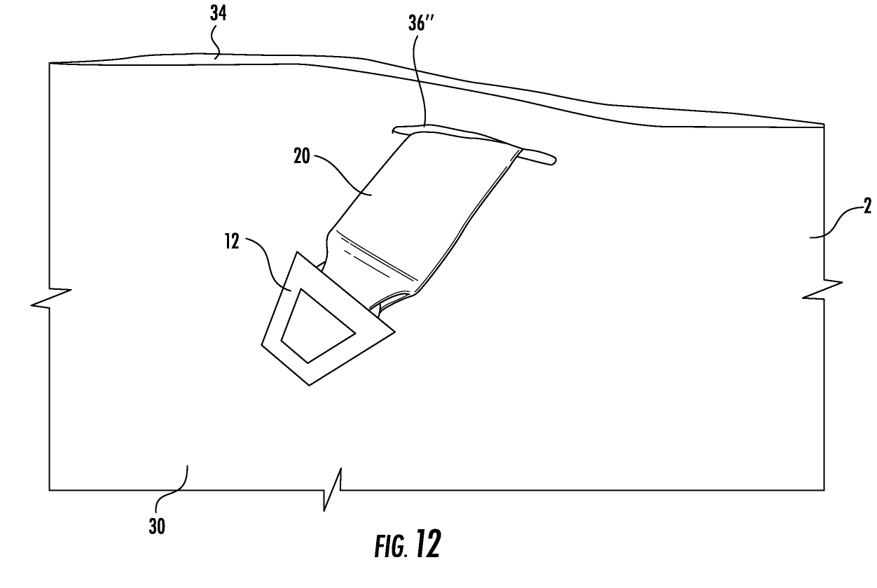

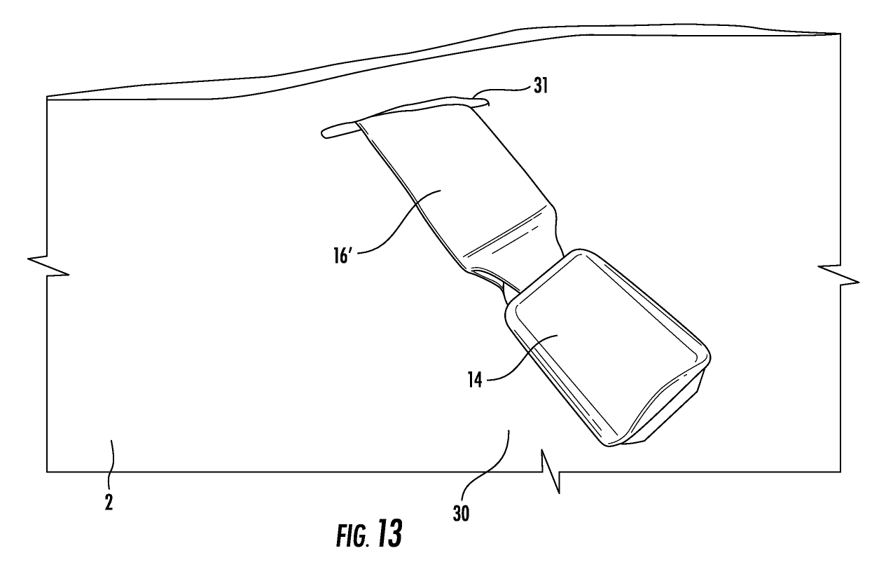

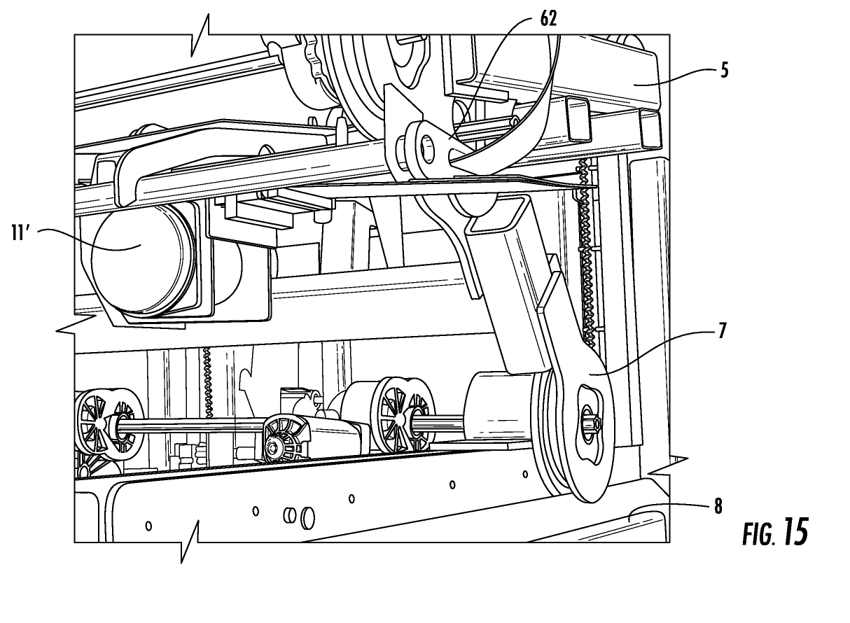

FIGS. 12 and 14 relate to embodiments in which a seatbelt retractor 11′ is provided mounted underneath the seat base 3, particularly underneath the seat frame 5. The seatbelt retractor 11′ may have features as described above with reference to seatbelt retractor 11.

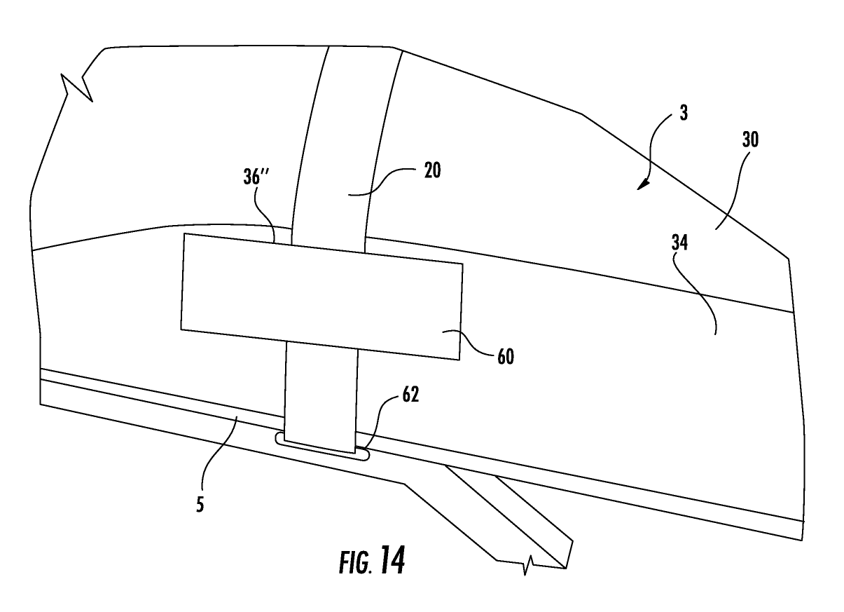

Each of the embodiments of FIGS. 12 and 14 provide belt and tongue sides of the seatbelt system 10. These may be used with any of the disclosed buckle side configurations. In particular, in addition to the buckle side configurations shown in FIGS. 5 and 6, a buckle configuration may be provided as shown in FIG. 13. Any of the buckle side configurations may be used in cooperation with any of the tongue side configurations. Further, the buckle side configurations shown in FIGS. 5 and 6 may be modified to include a cover similar to that shown in FIG. 7A, 7B, 8 and 10. Further, instead of providing the buckle side configuration with a rigid or semirigid buckle strap 16, the buckle strap may be formed of a flexible belt structure 16′ which is pivotably anchored to the frame 5 via a bolt 17. An embodiment of a buckle side configuration with a flexible belt structure 16′ is shown in FIG. 13. Further, still another buckle side embodiment may be provided based on the flexible belt structure 16′ being fixed to the frame 5 and the flexible belt structure 16′ being guided with a lateral belt guide 60 as shown in FIG. 14.

FIG. 12 shows the tongue side of the seatbelt system 10. The seatbelt 20 passes through a seatbelt guide recess 36″to pass through the seat base 3 from an underside of the cushion 3 to the upper surface 30 of the cushion 3. The opening of the guide recess 36″ is preferably suitably reinforced and may be sized relative to the tongue to belt connection so as to prevent the tongue 12 from passing into the guide recess 36″. The guide recess 36″ is preferably lined with a suitable plastic or material to allow the belt 22 to slide easily between a retracted position (shown in FIG. 12) and a deployed position in which the tongue 12 is engaged in the buckle 14. The opening of the guide recess 36″ has a length in the forward and aft direction to allow the belt 20 to be extended at the lie flat angle 26 or the TTL angle 22 or any angle in between these extremes. The seatbelt 20 preferably passes through a further guide 62 that is connected to the seat frame 5. The seatbelt 20 is then fed off and wound back on the spool of the seatbelt retractor 11′ (FIG. 15).

As shown in FIG. 13, the buckle 14 may be connected to a flexible strap 16′. The flexible strap 16′ is connected by the pivot bolt 17 to the seat frame 5 and passes though the seat base 3, through a buckle strap through passage 31. The length of the flexible buckle strap 16′ may be selected to provide a convenient and safe position for the buckle 14. The opening of the passage 31 has a length in the forward and aft direction to allow the buckle 14 to be extended at the lie flat angle 26 or the TTL angle 22 or any angle in between these extremes.

FIG. 14 shows a variation of the embodiment of FIG. 12, wherein the seatbelt 20 passes from the seatbelt retractor 11′ to a location above the cushion upper surface 30 by extending outwardly around the seat base 3. The seatbelt retractor is supported on the underside of the seat frame 5 as shown in FIG. 15. The lateral seatbelt guide 60 is provided laterally outwardly of the cushion side surface 34 of the seat part 3. The seatbelt guide 60 forms a belt guideway 36′″. Either the seat frame 5 or a part connected to the seat frame 5 supports one or more lower seatbelt guide 62. The lateral seatbelt guide 60 and the lower seatbelt guide 62 help transition the seatbelt 20 from extending laterally across the cushion upper surface 32 to extending laterally toward the seatbelt retractor 11′.

The guide 60 may have a feature to block the passage of the tongue 12 in a direction toward the lower belt guide 62. This allows the tongue 12 to be maintained adjacent to the cushion upper surface 30 and adjacent to the cushion tongue side surface 34 in a nonuse state. Further the opening of lateral guide recess 60 has a length in the forward and aft direction to allow the belt 20 to be extended at the lie flat angle 26 or the TTL angle 22 or any angle in between these extremes.

While specific embodiments of the invention have been shown and described in detail to illustrate the application of the principles of the invention, it will be understood that the invention may be embodied otherwise without departing from such principles.

### LIST OF REFERENCE CHARACTERS

1 airline seat
2 backrest
3 seat base (cushion)
4 leg rest
5 seat frame
6 trim and foam
7 adjustment frame/mechanism
8 subframe
9 airline floor
10 airline seatbelt arrangement
11 seatbelt retractor
11′
12 seatbelt tongue
13 retractor support
14 buckle
15 support pivot/bolt
16 buckle strap
16′ buckle strap
17 buckle strap pivot/bolt
18
20 seatbelt
22 seatbelt TTL angle
24 seatbelt neutral angle
26 seatbelt lie flat angle
30 cushion upper surface
32 cushion buckle side surface
31 buckle strap passage
32 cushion buckle side surface
33 buckle guide recess
34 cushion tongue (clasp) side surface
35 seatbelt guide opening/guide surface
35′ seatbelt guide slot
35″ seatbelt guide slot
36 retractor/belt guide recess
36′ retractor/belt guide recess
36″ belt guide recess
37 angled forward wall
39 rear wall
40 tongue/belt/retractor pivot directions
42 buckle pivot directions
44 tongue/belt/retractor pivot cover assembly
46 cover flip top
48 cover hinge
50 pull tab
52 upper cover portion
53 cover
54 side cover portion
55 cover
56 upper cover
58 side cover
60 lateral belt guide
62 lower belt guide

What is claimed is:

1. An airline seatbelt system comprising:
an airline seat frame;
a seat base connected to the airline seat frame, the seat base having a cushion upper surface;
a seatbelt retractor with a seatbelt, the seatbelt retractor being connected to the airline seat frame at a seatbelt connection location;
a seatbelt tongue connected to the seatbelt; and
a seatbelt guide connected to the seat base, the seatbelt guide providing a guideway for guiding the seatbelt and seatbelt tongue from a retracted position to a deployed position within an angular range relative to the seatbelt connection location, whereby the seatbelt and seatbelt tongue may be positioned in the angular range relative to the cushion upper surface in the deployed position.

2. An airline seatbelt system according to claim 1, wherein the seatbelt guide comprises a recess formed in the seat base and extending from a seatbelt retractor location to the cushion upper surface.

3. An airline seatbelt system according to claim 2, wherein the seatbelt retractor is pivotably mounted to the seat frame and is disposed in the recess formed in the seat base.

4. An airline seatbelt system according to claim 3, wherein the seatbelt guide further comprises a guide cover forming a portion of the cushion upper surface.

5. An airline seatbelt system according to claim 4, wherein the guide cover includes an upper cover portion forming a portion of the cushion upper surface and a side cover portion.

6. An airline seatbelt system according to claim 5, wherein the upper cover portion includes an elongate slot allowing the seatbelt to be moved, within the angular range, forwardly and rearwardly, relative to the seat base, within the elongate slot.

7. An airline seatbelt system according to claim 4, wherein the guide cover is comprised of a cover assembly comprising a flip up top pivotably connected to the seat base to pivot between an open position providing access to the seatbelt and the seatbelt tongue and a closed position closing off access to the seatbelt and seatbelt tongue.

8. An airline seatbelt system according to claim 7, wherein the cover assembly further comprises a cover base defining an upper surface with an elongate slot allowing the seatbelt to be moved, within the angular range, forwardly and rearwardly, relative to the seat base, within the elongate slot and the flip up top and the upper surface form a space for housing the tongue.

9. An airline seatbelt system according to claim 3, wherein:
the recess has an angled forward wall forming a retractor forward pivot stop and the recess has a rear wall forming a retractor rear pivot stop;
the retractor forward pivot stop and the retractor rear pivot stop set the angular range; and
the retractor is pivotable between the retractor forward pivot stop and the retractor rear pivot stop.

10. An airline seatbelt system according to claim 2, wherein:
the recess extends through the seat base from below the seat base to the cushion upper surface; and
the seatbelt retractor is located below the seat base.

11. An airline seatbelt system according to claim 10, wherein:
the recess has a forward wall forming a belt forward stop and the recess has a rear wall forming a belt rear stop.

12. An airline seatbelt system according to claim 2, wherein the seatbelt guide comprises side seat cushion strap, whereby the seatbelt guide is provided at a lateral side of the seat base and forms a belt passageway recess with the lateral side of the seat base and an upper edge of the seatbelt guide forms an elongate slot with a forward edge forming a belt forward stop and a rear edge forming a belt rear stop.

13. An airline seatbelt system according to claim 1, further comprising:
a buckle and a buckle connecting strap connecting the buckle to the airline seat frame, wherein the buckle is pivotably mounted to the seat frame; and
a buckle guide recess receiving the buckle and/or the buckle strap.

14. An airline seatbelt system according to claim 13, wherein the buckle guide recess has a forward wall forming a buckle or buckle connecting strap forward pivot stop and the buckle guide recess has a rear wall forming a buckle or buckle connecting strap rear pivot stop, wherein the a buckle or buckle connecting strap is pivotable between the a buckle or buckle connecting strap forward pivot stop and the a buckle or buckle connecting strap rear pivot stop.

15. An airline seatbelt system according to claim 12, further comprising a sliding strap connected to a lateral side of the seat base, the connecting strap extending through a region between the seat base and the sliding strap whereby the connecting strap is guided by the sliding strap for movement of the buckle, forwardly and rearwardly, relative to the seat base.

16. An airline seatbelt system according to claim 10, wherein the seat base includes a through recess passing through the seat base and the connecting strap extends through the through recess from a connection location with the seat frame to a buckle location above the cushion upper surface.

17. An airline seat comprising:
an airline seat frame;
a seat backrest connected to the seat frame;
a seat base connected to the airline seat frame, the seat base having a cushion upper surface;
a seatbelt retractor with a seatbelt, the seatbelt retractor being connected to the airline seat frame at a seatbelt connection location;
a seatbelt tongue connected to the seatbelt; and
a seatbelt guide connected to the seat base, the seatbelt guide providing a guideway for guiding the seatbelt and seatbelt tongue from a retracted position to a deployed position within an angular range relative to the seatbelt connection location, whereby the seatbelt and seatbelt tongue may be positioned in the angular range relative to the cushion upper surface in the deployed position.

18. An airline seat according to claim 17, further comprising:
a buckle and a buckle connecting strap connecting the buckle to the airline seat frame, wherein the buckle is pivotably mounted to the seat frame; and
a buckle guide recess receiving the buckle and/or the buckle strap, wherein the seatbelt guide comprises a recess formed in the seat base and extending from a seatbelt retractor location to the cushion upper surface.

19. An airline seat according to claim 18, further comprising an adjustment frame/mechanism for adjusting a position of the airline seat frame to move the seat backrest relative to the seat base between a taxi, takeoff and landing position and a lie flat position, wherein seatbelt guide guides a position of the seatbelt between a seatbelt lie flat position, with the seatbelt extending from the seatbelt guide essentially parallel to a seat base forward edge and a seatbelt taxi, takeoff and landing position with the seatbelt extending from the seatbelt guide toward the seat base forward edge.

20. An airline seat according to claim 18, wherein:
the seatbelt retractor is pivotably mounted to the seat frame and is disposed in the recess formed in the seat base;
the recess has a forward wall forming a retractor forward pivot stop and the recess has a rear wall forming a retractor rear pivot stop;
the retractor forward pivot stop and the retractor rear pivot stop set an angular range;
the retractor is pivotable between the retractor forward pivot stop and the retractor rear pivot stop;
the buckle guide recess has a forward wall forming a buckle or buckle connecting strap forward pivot stop and the buckle guide recess has a rear wall forming a buckle or buckle connecting strap rear pivot stop, wherein the a buckle or buckle connecting strap is pivotable between the a buckle or buckle connecting strap forward pivot stop and the a buckle or buckle connecting strap rear pivot stop.
